(19) United States
(12) Patent Application Publication
(10) Pub. No.: US 2013/0298618 A1
(43) Pub. Date: Nov. 14, 2013

(54) PROXIMITY AUTOLOCK TOOLBOX

(71) Applicant: WILLIAM GOTTER, Godfrey, IL (US)

(72) Inventor: WILLIAM GOTTER, Godfrey, IL (US)

(21) Appl. No.: 13/669,441

(22) Filed: Nov. 5, 2012

Related U.S. Application Data
(60) Provisional application No. 61/555,534, filed on Nov. 4, 2011.

(51) Int. Cl. E05B 47/06

(52) U.S. Cl. CPC E05B 47/06
USPC 70/280

(57) ABSTRACT

A proximity sensing toolbox lock is disclosed. A special motor powered autolock assembly is disclosed that attaches to convention tool boxes by pass through a standard “Double-D” profile keyhole to engage and move a 90 degree lock mechanism in response to an electrical or manual signal, A manual override is provided to disable the automatic operation if desired so that the lock can be operated by a key. Likewise, an override is provided to bypass the key lock and instead manipulate the lock using the assembly and not the manual (key) lock. The exemplary lock and autolock assembly can be adapted to a wide variety of containers and storage cabinets.

### CROSS REFERENCE TO RELATED APPLICATIONS

This application claims the benefit of U.S. Provisional Patent Application Ser. No. 61/555,534, filed Nov. 4, 2011, which is incorporated by reference herein as if set forth at length.

### BACKGROUND

1. Field

This invention relates to storage containers and to locking mechanisms for such containers. Suggested classification is 70/158.

2. Prior Art

Theft of took from open toolboxes is a common occurrence, particularly in factories or auto repair facilities where toolboxes are left open during shift work and other workers or the public have access. Workers may have manually or remotely operated locks, but frequent locking and unlocking of the toolbox results in loss work time, and inadvertence or diversion of attention may result in the toolbox being left open unintentionally even by attentive workers. A better solution is needed

Advantages

A small motorized locking assembly allows limited angular movement movement in response to either manual or automatic control.

### SUMMARY

An exemplary autolock assembly has a 90 degree lock/unlock movement, a manual key lock, a motorized lock, and a manual control for switching between key and motor locking to power said movement. A proximity sensing activation system is provided in a preferred embodiment to automatically activate said motorized lock to unlock said assembly when an activating device is near said assembly and to automatically lock said assembly when said device is not near said assembly. An exemplary autolock assembly is shown and described that is configured to be retrofitted onto a standard “Double-D” keylock hole of a toolbox lock so that an auto-locking toolbox is provided to assist in the prevention of tool theft, The autolock assembly is adaptable to a wide variety of storage containers, cabinets, lockers, drawers, closets, chests, and the like since it can fit through a standard “Double-D” profile keyhole to activate a standard 90 degree movement locking bar often found in such devices. The assembly could be modified easily to fit other keyhole profiles.

### DRAWINGS

The invention will be better understood by reference to the drawing and detailed description of an exemplary embodiment of the invention, recognizing that these figures are exemplary in order to satisfy best mode, enablement and written description requirements, In this exemplary drawing:

FIG. 1 is a top plan view showing two parts of a first exemplary autolock assembly 100;

FIG. 2 is an enlarged view in partial cross section of knob 118 of FIG. 1;

FIG. 3 is a top view of an upper portion 300 of gear wheel 143 of FIG. 1;

FIG. 4 is a side view of portion 300;

FIG. 5 is a top view of a locking positive stop carrier disc 133 of FIG. 1;

FIG. 6 is a side view of disc 133;

FIG. 7 is a top view of a cam wheel of FIG. 1;

FIG. 8 is a side view of the cam wheel of FIG. 7;

FIG. 9 is a side view of a bottom busing of FIG. 1;

FIG. 10 is a bottom view of the bottom bushing of FIG. 9;

FIG. 11 is a side view of a bottom bolt of FIG. 1;

FIG. 12 is a cross sectional view taken along line 12-12 of FIG. 11 to show passage of electrical wires through bolt 138;

FIG. 13 is an inside view (i.e., from the bottom looking up in FIG. 1) of clutched selector disc 131 of FIG. 1;

FIG. 14 is a top vertical cross-sectional view (i.e. from the front looking toward the rear in FIG. 1) of selector disc 131 taken along lines 1444 of FIG. 13; and

FIG. 15 is a schematic diagram of a proximity sensing system for controlling the assembly of FIG. 1.

FIG. 16 is perspective view from inside a toolbox showing a second exemplary embodiment;

FIG. 17 is an inside view of the cylinder plate of FIG. 16;

FIG. 18 is an inside view of the cylinder plate of FIG. 16; and

FIG. 19 is an inside view similar to FIG. 18 except showing a third exemplary embodiment using a stepper motor to rotate the cylinder plate.

### DETAILED DESCRIPTION

First Exemplary Embodiment

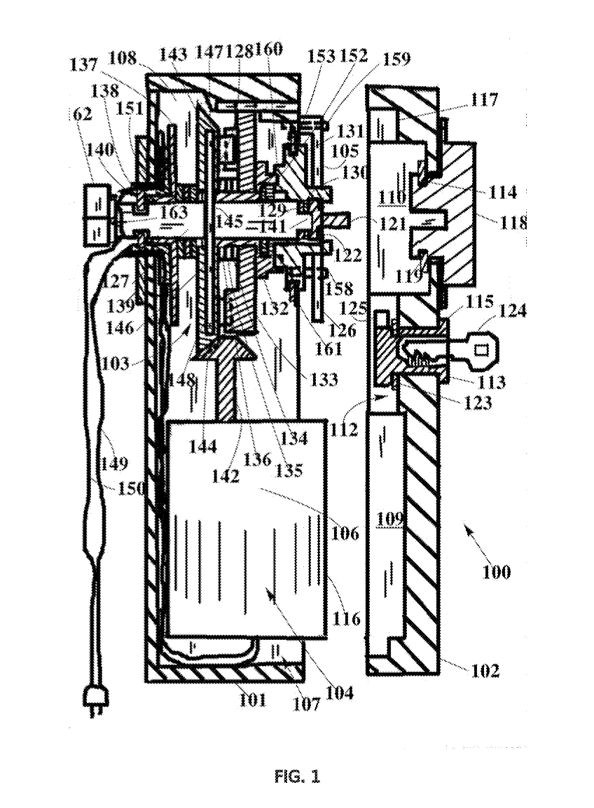

FIG. 1 is a top plan view showing an exemplary autolock assembly 100 contained within an inner housing 101 and an outer housing 102. Inner housing hold a clutch unit 103, a motor unit 104 and a manual pivotally mounted override bar 105 having an indexing rod 158 at one end and a pivot 159 at the other end. Inner housing 101 and outer housing 102 are of machined corrosion resistant metal such as stainless steel or aluminum. Inner housing 101 has a motor cavity 107 configured to snugly hold a small electric motor 106 and a dutch cavity 108 configured to hold unit 103. Outer housing 102 has motor cavity 109, a dutch cavity 110, a keylock cavity 112, a first passageway 114, and a second passageway 115. Motor cavity 109 snugly fits a top 116 of motor 106, a dutch cavity 110 and first passageway 114 configured to surround and contain a top portion 111 of unit 103, and a keylock cavity 112 configured to contain a keylock 113. Clutch cavity 110 has a side recess 117 to contain a left side of bar 105. An manual override knob 118 is held in passageway 114 by a snap ring 119. Knob 118 has a slot 120 conforming to and adapted to receive a lug 121 of a force piston 122 atop dutch unit 103, so that when housing 102 and housing 101 are fastened together and knob 118 is rotated, piston 122 is rotated. Keylock 113 is held tightly within passageway 115 by a snap ring 123, so that when key 124 is rotated a tab 125 of keylock 113 is rotated so as to engage and move the right end 126 of bar 105 for purposes described below.

FIG. 1 also shows dutch unit 103, which comprises a pivotally mounted override bar 105, a drive shaft 127, crossrod 128, piston 122, two washers 129 and 130, a selector disc 131 with opposed downwardly projecting stops 160 and 161, an outer dutch plate 132, two spacer washers 152 and 153, a positive stop carrier disc 133, three washers 134, 135 and 136, a gear wheel 143, an inner bushing 137, a double-D conductor adapter bolt 138, a nut 139, and an inner snap ring 140. Shaft 127 is a chrome steel cylinder with a reduced diameter outer end 141. Crossrod 128 passes through a passageway 145 in shaft 127 and a passageway 146 in dutch plate 132 is affixed at its left side 147 and right side 148 to gear wheel 143 so that when gear wheel 143 rotates so does dutch plate 132 and shaft 127. Likewise the lower end of dutch plate 132. Bushing 137 is specially configured to an existing “Double-D” lock hole 151 of the container. Also the adapter bushing that the wires run through should make reference to being especially for a Double-D profile. A square adapter 162 is attached by a set screw 163 or other fastener to shaft 127, so that any suitable adapter can he substituted to conform to whatever existing locking mechanism is present

FIG. 1 further shows motor unit 104, which comprises motor 106, drive shaft 142, and electrical power wires 149 and 150, with drive shaft 142 having a pinion gear end 144 engaged with gear wheel 143. When power is provided through wires 149 and 150 to motor 106, shaft 142 is rotated to turn gear wheel 143. Motor 106 is reversible, so that wheel 143 can be selectively rotated either clockwise or counterclockwise and desired for locking and unlocking.

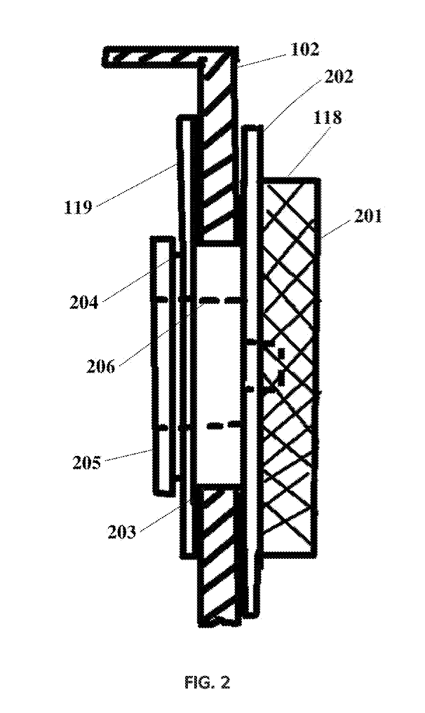

FIG. 2 is an enlarged view of knob 118. Knob 118 has a knurled outer portion 201, a smooth flange 202, and a cylindrical inner portion 203. Portion 203 has an annular recess 204 near an inner end 205. Recess 204 receives snap ring 119 to hold knob tightly onto outer housing 102. Portion 203 has slot 120 and a axial right cylindrical recess 206 designed to receive, respectively the top of selector disc 131 and lug 121. Selector disc 131 is able to rotate within recess 206 and lug 121 is keyed in slot 120 to force co-rotation of piston 122 with knob 118.

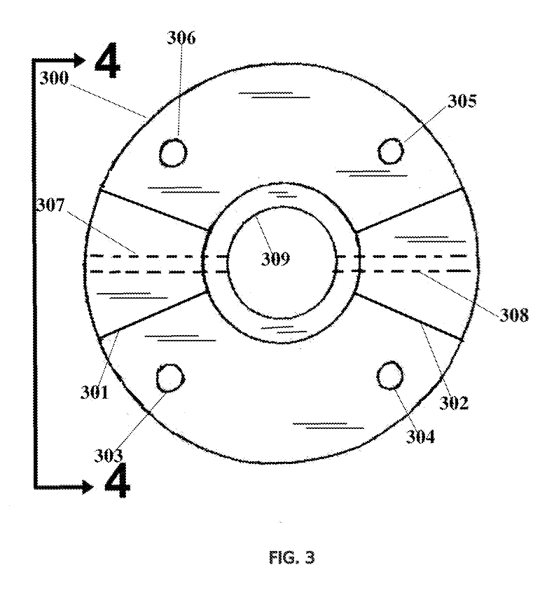

FIG. 3 is a top view of an upper portion 300 of gear wheel 143. Portion 300 is an annular metal body with a central bore 309 and semi-cylindrical channels 307 and 308 which are adapted to receive left side 147 and right side 148 of crossrod 128. Portion 300 is placed atop a gear wheel 143 sides 147 and 148 in channels 307 and 308 and is then attached to wheel 143 by fasteners 303,304,305,306 to capture rod 128. Portion 300 provides a first stop 301 and a second stop 302 that are lugs configured to limit angular movement of wheel 143 in both directions to 90 degrees, as that is the customary movement for locking and unlocking of a toolbox lock.

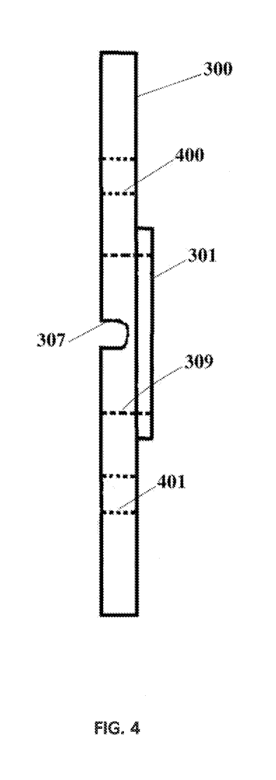

FIG. 4 is a side view of portion 300 taken along lines 4-4 and showing stop 301, channel 307, bore 309, and passageways 400 and 401 for fasteners 303,304,305, and 306.

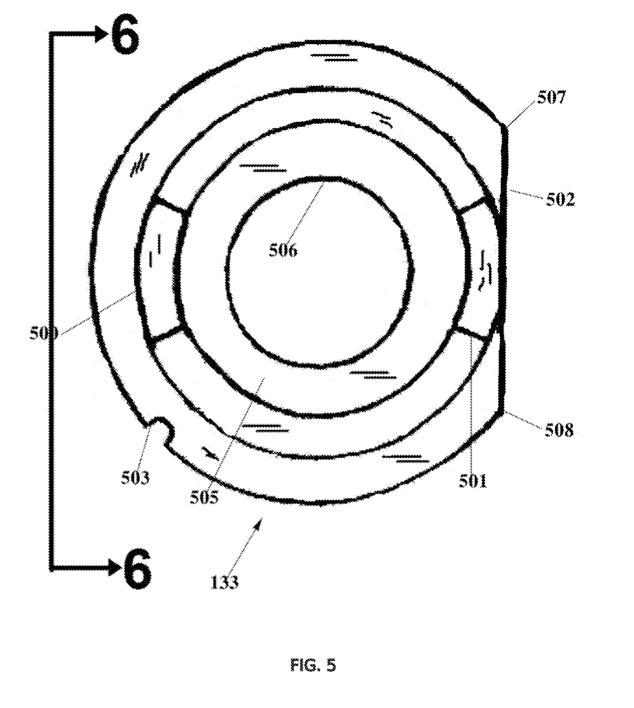

FIG. 5 is a bottom view of positive stop carrier disc 133, showing stops 500 and 501 which engage with stops 301 and 302 to limit shaft 127 to 90 degrees of rotation, as noted above with reference to FIG. 3. Disc 133 has a flat right side 502 that is flattened between corner 507 and corner 508 to provide room for pinion gear 144, Disc 133 has a recess 503 to receive a pin 504 (see FIG. 1) to hold disc 133 in steady position within inner housing 101 so that disc 133 does not rotate with shaft 127. Disc 133 has a slightly recessed annular portion 505 surrounding a central bore 506. Portion 505 is recessed in order to better retain washers 134, 135 and 136

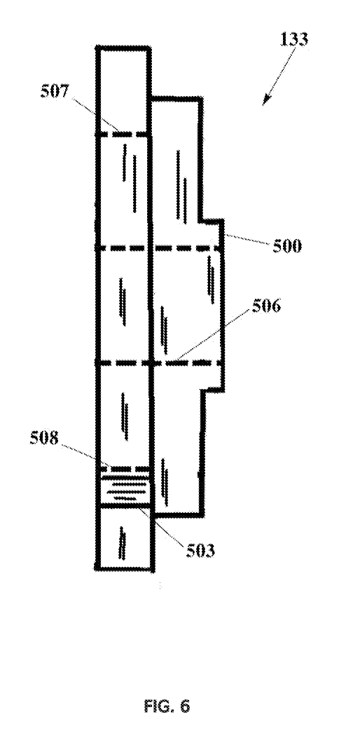

FIG. 6 is a side view of disc 133 taken along lines 6-6 of FIG. 5 showing central bore 506 (in phantom), recess 503, corners 507 and 508 (in phantom) of side 502 and stop 500.

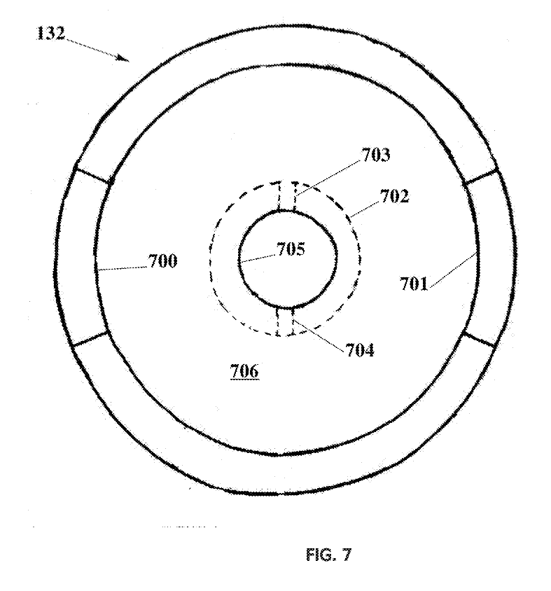

FIG. 7 is a top view of outer clutch plate 132, which has upwardly extending stops 700 and 701, and upwardly facing recess 706 and a downwardly extending tubular cylindrical sleeve 702 with a central bore 705 adapted to receive shaft 127, Sleeve 702 has radial passageways 703 and 704 which are adapted to receive and engage left side 147 and right side 148 so that plate 132 rotates with shaft 127. Recess 706 is configured to receive washers 152 and 153 to set the spacing between selector disc 131 and plate 132 and to serve as a clutch to allow selector disc 131 to move relative to plate 132 or vice versa if either is restrained and the other has rotary force applied thereto.

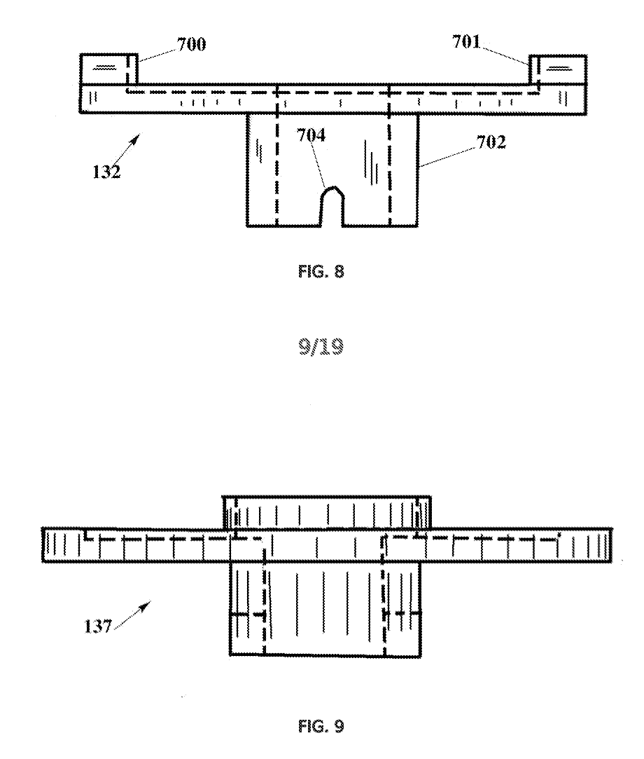

FIG. 8 is a side view of plate 132, showing stops 700 and 701 projecting upward and sleeve 702 downward, with radial passageway 704,

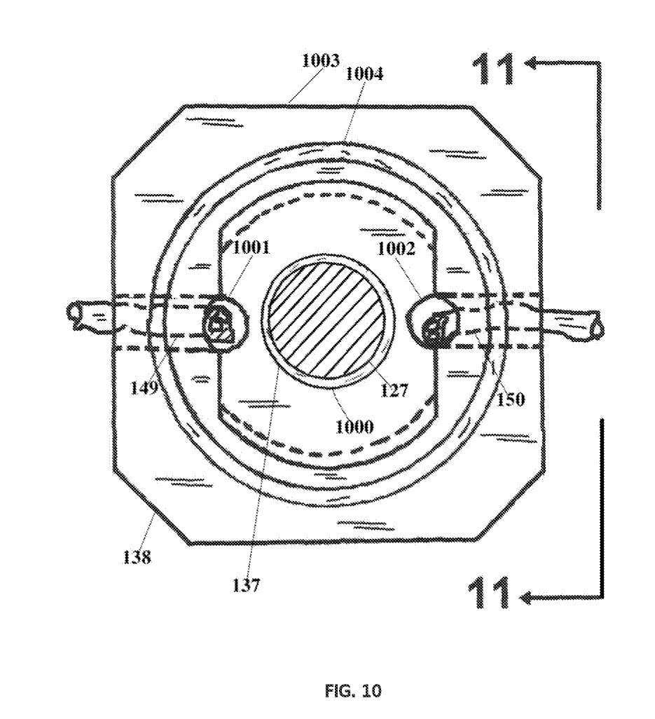

FIG. 9 is a side view of a bottom bushing 137, which is an inner part of a double-D conduction adapter, so called because it fits a conventional lock passageway for a Double-D lock shaft.

FIG. 10 is a bottom view of double-D conduction adapter bolt 138, and for better understanding also showing wire 149, wire 150, shaft 127 (in cross-section) and a bottom 1000 of bushing 137. Wire 149 passes through a side channel 1001 and wire 150 passes through a side channel 1002. Bolt 138 has a polygonal flange 1003 and a short round tubular portion 1004 extending downwardly from flange 1003. Bolt 138 also has a double-D configuration threaded

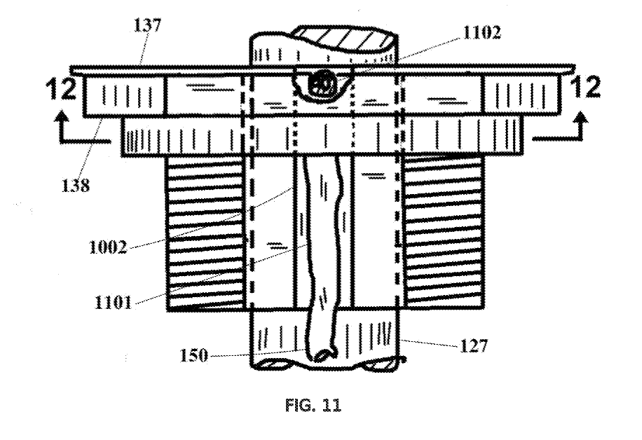

FIG. 11 is a side view of a double-d conduction adapter bolt 138 and bushing 137 assembled about shaft 127 to show how and outer portion 1101 of wire 150 extends through a side channel 1002 and inner portion 1102 extends radially through a radial channel 1002 to allow power to be supplied from within the toolbox or cabinet being protected through bolt 138 to motor 106 in the interior of housing 101 without being accessible from outside housing 101; and

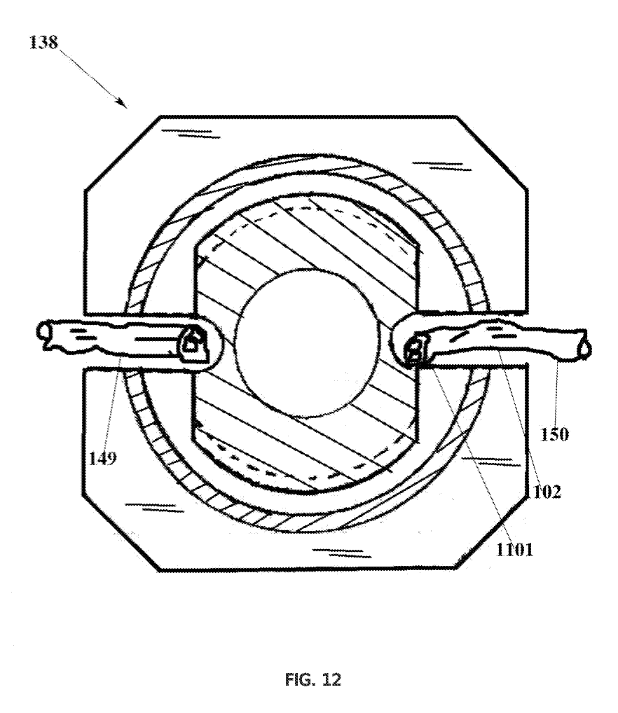

FIG. 12 is a cross sectional view taken along line 12-12 of FIG. 11 to show passage of outer portion 1101 and inner portion 1102 through bolt 138, omitting the inner bushing 137;

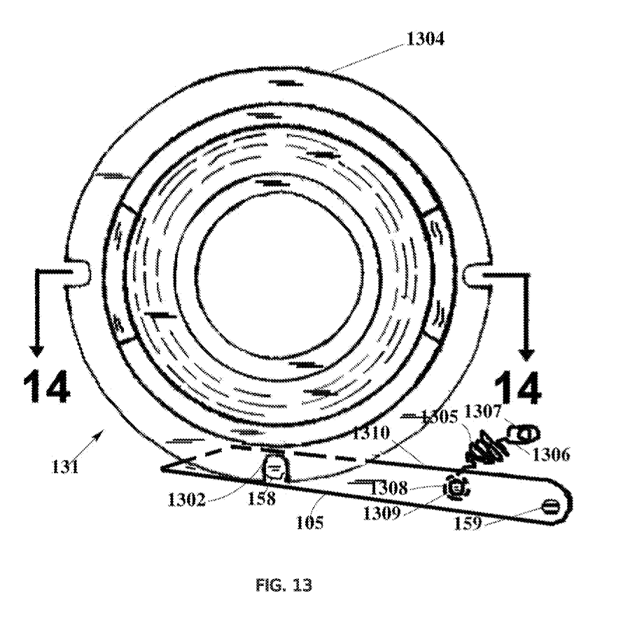

FIG. 13 is a top view of clutched selector disc 131 and selector bar 105. Bar 105 appears to be a single bar, but is actually two thin flat bars with an appearance similar to a pair of parallel spaced metal collar stays with pin 158 and pin 1309 maintaining the spaced position. In FIG. 13 only the upper bar 1310 is seen in FIG. 13. A solid selector bar could be used, but the spaced configuration lets bar 105 pass over the periphery 1304 of selector disc 131 so that pin 158 can fully engage slots 1301, 1302, and 1303. Slot 1301 is at the left side 1400 and slot 1303 at the right side 1401 disposed 180 degrees apart with slot 1302 midway between. A selected one of slots 1301,1302,1303 is engaged by pin 158 of bar 105 under the resilient force of tension spring 1305. Spring 1305 has a first end 1306 looped around a post 1307 attached to housing 101 (not shown) and a second opposite end 1308 looped around a pin 1309 of bar 105. Spring 1305 pulls selector arm 105 into resilient engagement with selector disc 131 so that when disc 131 is rotated, pin 158 will fall into and remain in one of slots 1301, 1302, 1303 set whether the autolock assembly is in autolock mode, manual (key mode) or locked. Selector disc 131 has a first slot 1301, a second slot 1302 and a third slot 1303 on an outer circumference surface 1304. Slot 1301 and slot 1303 are 180 degrees apart along surface 1304 and slot 1302 is midway between slot 1301 and slot 1303, that is ninety degrees along surface 1304 from slot 1301 and ninety degrees from slot 1303. Slots 1301, 1302 and 1303 serve to index unit in cooperation with indexing rod 158.

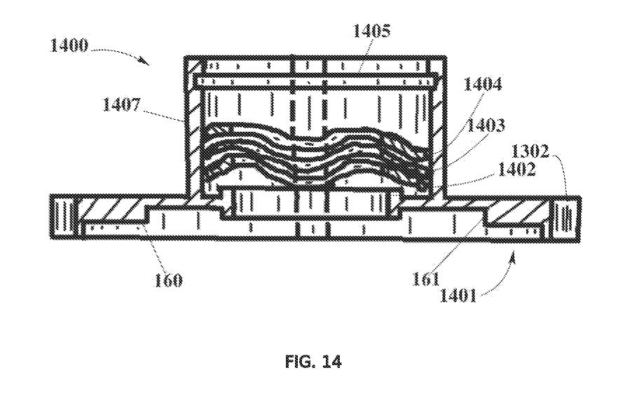

FIG. 14 is a side vertical cross-sectional view of indexing bar 105 and exemplary selector disc 131 taken along lines 14-14 of FIG. 13., to show operation of bar 105 and selector disc 131. Three wavy spring washers 1402,1403 1404 are disposed in tubular portion 1407. Portion 1407 has an annular snap ring recess 1405 to allow selector disc 131 to be held in position

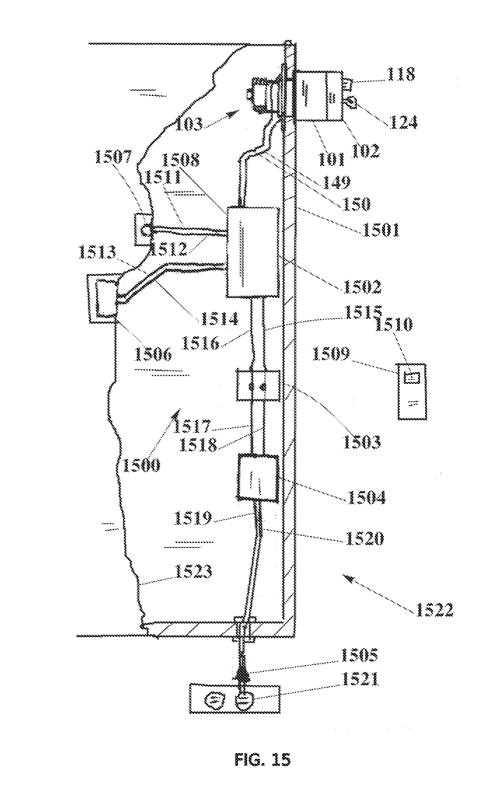

FIG. 15 is top plan view of a tool box 1522 with its lid 1523 partially cutaway to reveal a proximity sensing system 1500 within toolbox 1522 for controlling autolock assembly 100 mounted in housing 101 and housing 102 on a front wall 1501 of an industrial toolbox (not shown). System 1500 comprises a K-9 Sombra PHD proximity sensor 1502, a small 12V DC backup battery 1503, a 110V AC to 12V DC float charger 1504, a 110V AC plug 1505, a siren 1506, an LED status indicator light 1507, an override button 1508, and an RHD transmitting device 1509 such as a badge or card containing an appropriate signal generator 1510. Wires 149 and 150 connect assembly 100 to sensor 1502 of sensing system 1500. Wires 1511 and 1512 connect sensor 1502 to light 1507, Wires 1513 and 1514 connect sensor 1502 to siren 1506, Wires 1515 and 1516 connect sensor 1502 in parallel to battery 1503. Wires 1517 and 1518 connect battery 1503 and charger 1504. Wires 1519 and 1520 connect charger 1504 to plug 1505 and plug 1505 would be plugged into a standard 110V AC wall socket 1521 to receive electrical power. While system 1500 is shown in FIG. 15 placed in the lid of toolbox 1522, it will be understood that the parts can be placed wherever is most convenient and compact for a given toolbox design to keep them out of the way, generally inaccessible and even, if desired, in a locked compartment within the toolbox so system 1500 cannot be tampered with even when toolbox 1522 is unlocked and open, This provides a quantum jump in the level of security for toolboxes.

Operation of First Exemplary Embodiment

Referring first to FIG. 15, plug 1505 is plugged into socket 1521 to power up charger 1504 through wires 1519 and 1520, which provides power through wires 1517, 1518, 1516 and 1515 to proximity sensor 1502 which then is initialized and begins looking for a specific activation signal from generator 1510. When device 1509 is thus detected by sensor 1502, sensor 1502 sends a signal via wires 149 and 150 to autolock assembly 103. If assembly 103 is in automatic mode, as set by knob 118 and disc 131, motor 106 moves clutch unit 103 so as to rotate adapter 162 ninety degrees to unlock cabinet 1522. This would be done at initial installation. After that system 1500 would generally remain powered so that locker, drawer, cabinet or toolbox 1522 would be automatically opened at the start of a worker's shift when the worker with the proper RFID badge came in proximity to toolbox 1522. When the worker (not shown) goes to the restroom, break room, lunch, to visit another location in the plant to address a problem or just socialize, sensor 1502 fails to sense the presence of generator 1510 and in similar fashion reverses power and causes motor 106 to reverse and dutch unit 103 to relook toolbox 1522. When the worker returns, sensor 1502 once again senses generator 1510 and the process repeats itself and continues repeating throughout the workday. As noted this provides a quantum leap in the level of security for workplace toolboxes and thus, if adopted, could virtually eliminate theft of valuable tools from tool lockers, tool cabinets, toolboxes, dispensaries, drug cabinets, pharmaceutical storage units, cash registers, and an almost infinite variety of locked storage places of all types.

The exemplary embodiment has so many figures because it is no easy or obvious task to design a compact automatic motorized lock driving unit that can fit on the outside of toolbox (to conserve valuable space within the toolbox) and be secure yet able to be powered through a standard Double-D profile locking hole as most convention toolboxes have. This rather complex design achieves that seemingly insurmountable task and does it compactly and effectively with a sleek exterior that is tamper proof. Indeed, since from the outside appearance it is not even clear where the hidden locking hole is located, the toolbox is better protected even against deliberate tampering such as with a drill. It is believed the operation of the system is made abundantly clear from the drawings and the structure description above such that any person of ordinary skill in the art of toolbox and lock design is enabled to replicate the invention. Specific dimension are omitted as those will depend on the particulars of the storage cabinet sought to be locked and unlocked using the system 1500.

Second Exemplary Embodiment

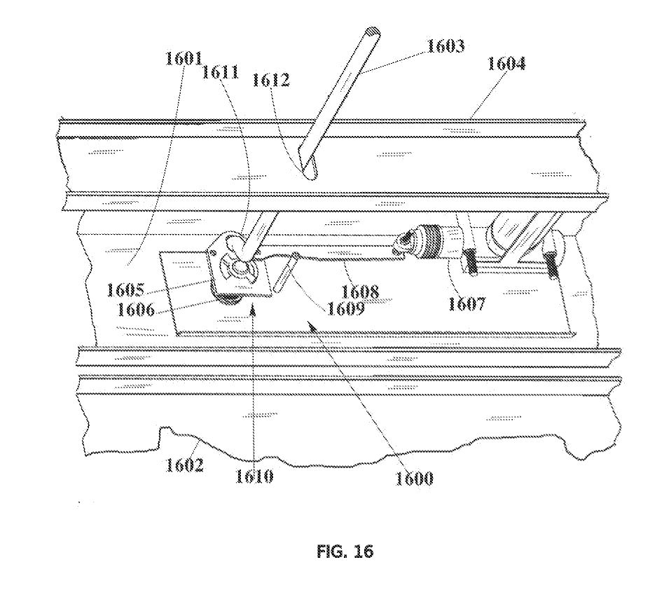

FIG. 16 is perspective view from inside a toolbox showing a second exemplary autolock assembly 1600 mounted inside a toolbox lid 1601 of a toolbox 1602 having, by way of example for purposes of illustration, a locking rod 1603 that rotates to move into and out of engagement with toolbox 1602 to prevent opening lid 1601. Assembly 1600 includes a locking plate 1605, a cylinder 1606, a linear actuator 1607, an actuator arm 1608, and a support post 1609. Plate 1605 is shown in an unlocked vertical first position 1610. Rod 1603 passes through a vertical slot 1612 in a lid support rail 1604, Rod 1603 includes a dogleg 1611 so that when plate 1605 rotates, rod 1603 is laterally restrained by slot 1612 and thus forced to rotate by the circular movement of dogleg 1611.

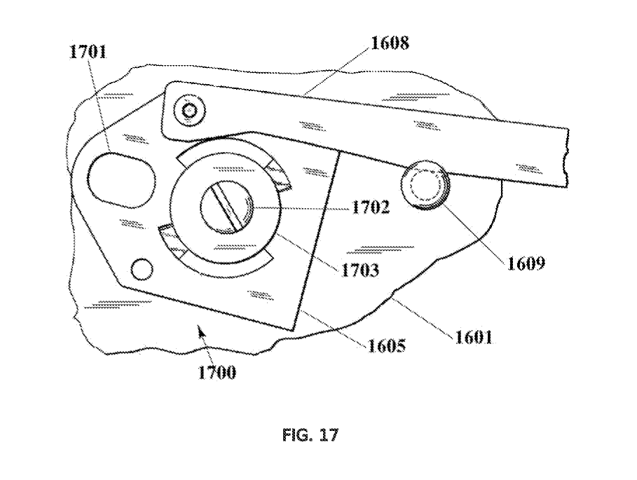

FIG. 17 is a magnified inside view of plate 1605 in a second position 1700 showing plate 1605 rotated counter-clockwise into a locked position. Rod 1603, omitted for clarity, would lie within opening 1701 of plate 1605. Plate 1605 is fastened to cylinder 1606 by machine bolt 1702 and washer 1703.

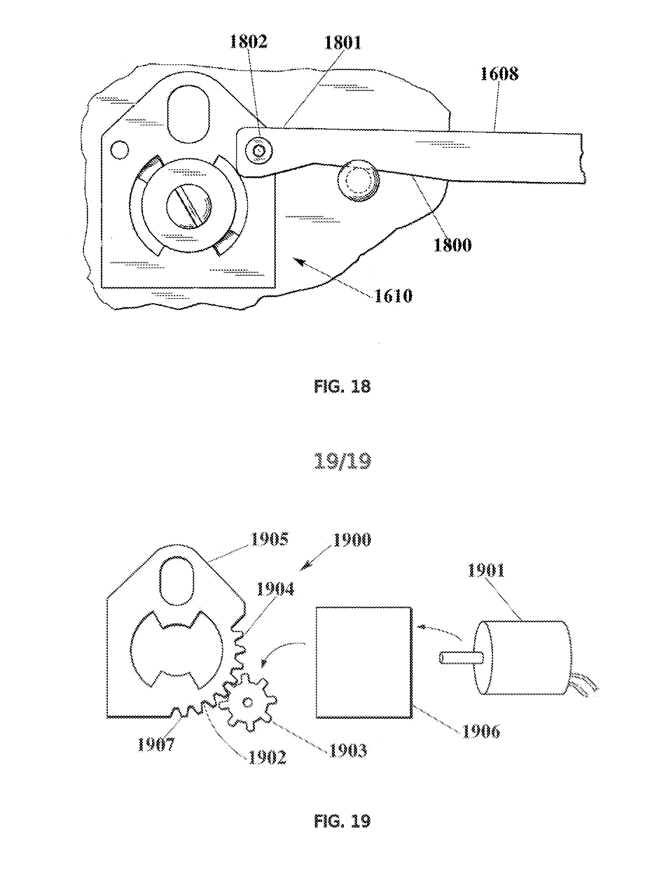

FIG. 18 is a magnified view of plate 1605 in position 1610 and arm 1608 moved to the right relative to the position in FIG. 17. Arm 1608 is provided with a tapered section 1800 to allow support post 1609 to still support end portion 1801 of arm 1608 in this slightly lower vertical position so as to avoid excess pressure on connection 1802 between arm 1608 and plate 1605.

Operation of Second Exemplary Embodiment

Referring first to FIG. 16, actuator 1607 has retracted to pull arm 1608 to the right to place plate 1605 in an unlocked vertical first position as shown in FIG. 18. Upon receipt of a locking signal, actuator extends to push arm 1608 to the left to rotate plate 1605 counter-clockwise to the position shown in FIG. 17, Such rotation of plate 1605 in turn rotates rod 1603 to lock lid 1601 to toolbox 1602 in the usual manner such as seen in U.S. Published Patent Application No. 2011/0185779A1 to Crass, et al. and assigned to Snap-On, Incorporated. However, in this embodiment a proximity sensor like that described in FIG. 15 would be provided to operate actuator 1607. As noted this provides a quantum leap in the level of security for workplace toolboxes and thus, if adopted, could virtually eliminate theft of valuable took from tool lockers, tool cabinets, toolboxes, dispensaries, drug cabinets, pharmaceutical storage units, cash registers, and an almost infinite variety of locked storage places of all types.

Third Exemplary Embodiment

FIG. 19 is an inside view similar to FIG. 18 except showing a third exemplary autolock assembly 1900 which is similar to assembly 1600 except using a stepper motor 1901 and a toothed locking plate 1905, Plate 1905 has gear teeth 1902 which are driven by a gear 1903 powered by motor 1901 under control of a control unit 1906. Assembly 1900 would be mounted inside toolbox lid 1601 similar to the manner of mounting actuator 1607 to rotate plate 1905. While gear 1903 is shown position midway along teeth 1902, gear 1903 would be positioned at the upper right end 1904 when plate 1905 was in the unlocked position and at an opposite lower left end 1907 when in the unlocked position.

Operation of Third Exemplary Embodiment

Stepper motor 1901 would be configured by programming control unit 1906 to rotate plate 1605 in similar fashion to the push and pull of arm 1608 of assembly 1600, except that this would be done by rotating gear 1903 engaging teeth 1902 to achieve rotation. Motor 1901 would rotate gear 1903 clockwise to unlock assembly 1900 and counterclockwise to lock assembly 1900. Whether a linear actuator 1607 or stepper motor 1901 or the external housing system of assembly 100 is chosen is a design choice, as assembly 100, assembly 1600, and assembly 1900 are all designed to move plate 1605 between position 1610 and position 1700 repeatedly in response to proximity signals while still achieving a conventional key lock capability and to be retrofit to existing toolboxes 1602.

Conclusion, Considerations, and Coverage

Accordingly the reader will see that, according to the invention, l have provided an auto-locking assembly for locked containers that can be delivered to users in kits to replace existing locking assemblies. It will be understood that the exemplary system 1500 and exemplary autolock assembly 100 are just that, examples of a currently preferred mode of the invention. However, examples would come to mind as alternatives for assembly 103, such as an internal system within a toolbox as shown in assembly 1600 and assembly 1900. Any of the systems could work with a multi-position keylock cylinder that would fit within a standard Double-D hole and switch an internal locking unit from manual to automatic. And different sensors, alarms, lights, bells, whistles etc. could be incorporated. With modern computer systems, even wireless, the RHD proximity sensor might be replaced with a wireless local network based signal generation so that a production control supervisor could, for example automatically open and close all locks in a selected portion of a factory remotely from an office using retrofit kits such as that in autolock assembly 100, assembly 160o0p or assembly 1900 or any variant thereof.

So, as noted, while the above description contains many specifics, various alternatives are shown so these are not limitations on the scope of the invention, but rather illustrative exemplifications of the various embodiments thereof, Many other embodiments are possible within the teachings of the invention.

Thus coverage in the claims below should be determined by the claims and their legal equivalents, and limited only by the prior art and not ted to the examples given.

What is claimed is:

1. A locking assembly for a storage container, comprising: a housing attachable to an exterior of said toolbox and configured to overlie a conventional lock hole, a motor within said housing, a locking unit partially contained within said housing in operative engagement with said motor and partially extending through said lock hole to operate a conventional locking mechanism within said toolbox, and a control for selectively operating said motor to lock and unlock said container.

2. The locking assembly of claim 1 wherein said control includes a proximity sensor.

3. The locking assembly of claim 2, further comprising an identification device and a control unit, said control unit including said proximity sensor and interposed electrically between said source and said motor and configured to operate said motor to automatically lock and unlock said toolbox in response, respectively, to the absence or presence of said device in proximity to said toolbox.

4. The locking assembly of claim 4, wherein said motor is a linear actuator within said housing.

5. The locking assembly of claim 4, wherein said motor is a stepping motor within said housing.

6. The locking assembly of claim 6, wherein said motor is reversible to rotate either forward or reverse in response to forward or reverse signals,

7. The locking assembly of claim 4, wherein said motor is a non-stepping motor within said housing

8. A locking assembly kit for remotely locking a storage container, comprising: an adapter configured to pass through a standard lock aperture, a housing configured for placement over a standard lock hole, an electric motor within said housing, a electrical power source within one of said cabinet, a converter for converting motion of said motor into rotation of a shaft passing through said aperture to operate a locking mechanism located within said cabinet, and an adapter passing through said aperture surrounding said shaft, said adapter having passageway for electrical wires to pass to connect said motor to said power source.

9. The locking assembly of claim 1 wherein said control includes a proximity sensor,

10. The locking assembly of claim 3, further comprising an identification device and a control unit, said control unit including said proximity sensor interposed electrically between said source and said motor and configured to operate said motor to automatically lock and unlock said toolbox in response, respectively, to the absence or presence of said device in proximity to said toolbox.

11. The locking assembly of claim 4, wherein said motor is a linear actuator within said housing.

12. The locking assembly of claim 4, wherein said motor is a stepping motor within said housing.

13. The locking assembly of claim 6, wherein said motor is reversible to rotate either forward or reverse in response to forward or reverse signals.

14. The locking assembly of claim 4, wherein said motor is a non-stepping motor within said housing.

15. The locking assembly of claim 4, wherein said control unit further comprises means sense the presence of an identification device in proximity to said toolbox and permit

16. A locking assembly for a toolbox, comprising: a motor operatively connected to a locking mechanism, said locking mechanism located within said toolbox, an identification device, and a proximity sensor operatively connected to said motor and configured to operate said motor to automatically lock and unlock said toolbox in response, respectively, to the absence or presence of said device in proximity to said toolbox.

17. The locking assembly of claim 4, wherein said motor is a linear actuator within said toolbox.

18. The locking assembly of claim 4, wherein said motor is a stepping motor within said toolbox.

19. The locking assembly of claim 6, wherein said motor is reversible to rotate either forward or reverse in response to forward or reverse signals.

20. The locking assembly of claim 4, wherein said motor is a non-stepping motor within said toolbox.
